(19) United States
(12) Patent Application Publication
(10) Pub. No.: US 2013/0044496 A1
(43) Pub. Date: Feb. 21, 2013

(54) LUMINOUS-FLUX CONTROL MEMBER AND ILLUMINATION APPARATUS USING THE SAME

(71) Applicants: Akinobu Seki, Saitama (JP); Noriyuki Kawahara, Saitama (JP); Kyouhei Yamada, Saitama (JP); Hiroshi Takatori, Saitama (JP)

(72) Inventors: Akinobu Seki, Saitama (JP); Noriyuki Kawahara, Saitama (JP); Kyouhei Yamada, Saitama (JP); Hiroshi Takatori, Saitama (JP)

(21) Appl. No.: 13/637,190

(22) PCT Filed: Mar. 18, 2011
(86) PCT No.: PCT/JP11/01616

§ 371 Date: Sep. 25, 2012

(30) Foreign Application Priority Data
Mar. 26, 2010 (JP) 2010-073690

(51) Int. Cl. F21V 5/04

(52) U.S. Cl. 362/311.02

(57) ABSTRACT

Provided are a lighting lens and an illumination apparatus including the same that can improve color rendering properties and prevent reductions in performance of a light flux controlling member and in illuminance on a surface to be illuminated when a pseudo-white LED is used. This lighting lens (1) includes a color adjustment unit (14) that contains a color adjusting material, is excited by light emitted from an LED (2) and emits light in a color different from the light-emitting color of the LED (2). The color adjustment unit (14) is disposed at a portion through which sub-rays other than main rays pass and not at a portion through which the main rays pass, the main rays being rays having a luminous intensity equal to or more than a predetermined percentage of the maximum luminous intensity.

### TECHNICAL FIELD

The present invention relates to a light flux controlling member that controls the direction of light emitted from a light emitting diode (LED) and an illumination apparatus including the same.

### BACKGROUND ART

In recent years, illumination apparatuses that emit the light emitted from light emitting diodes (LEDs) through lighting lenses serving as light flux controlling members have spread rapidly. Such illumination apparatuses including LEDs are required to control light fluxes in accordance with requirements and to change the color of the emitted light to white similar to that of natural light.

Unfortunately, an LED alone can emit only light with a predetermined narrow wavelength range, and thus cannot generate native white light having a continuous spectrum over the entire visible light range.

A measure to cope with this problem is use of a pseudo-white LED. The pseudo-white LED generates a pseudo white color by mixing blue light emitted from a blue-light emitting LED chip and yellow light yielded from the blue light which excites yellow fluorescent materials in a sealing material covering the LED chip.

An illumination apparatus including such a pseudo-white LED have poor color rendering properties, for example, dull-looking red or cardinal red, because of an uneven spectrum distribution of the light generated from the pseudo-white LED.

To address these problems, a method for enhancing color rendering properties have been used in a conventional illumination apparatus including a pseudo-white LED, for example, compounding of color-adjusting particles that functions as a color adjustment unit in a sealing material, or an attachment of a color adjustment unit to a lighting lens which is separate from the LED, to allow the light emitted from the LED to pass through the color adjustment unit (See Patent Literatures 1 and 2). The color adjustment unit contains a red or green fluorescent material which is excited by light emitted from the LED to cause light to emit in a color different from the light-emitting color of the LED, or contains a coloring material, such as pigment or dye, which causes light to emit in a color different from the light-emitting color of the LED.

### CITATION LIST

### Patent Literature

### PTL 1

### Japanese Patent Application Laid-Open No. 2009-43972

### PTL 2

### Japanese Patent Application Laid-Open No. 2007-35882

### SUMMARY OF INVENTION

### Technical Problem

Because of lack of consideration of the fact that the luminous intensity of light depends on the emission angle of light from the LED, these conventional apparatuses also have color adjustment units disposed at portions of the lighting lenses where light having a high luminous intensity passes through. As a result, light having a high luminous intensity is scattered or absorbed by the fluorescent material or pigment in the color adjustment unit, resulting in significant reductions in performance of the conventional lighting lens, which serves as a light flux controlling member, and in illuminance on an illuminated surface, although an illumination apparatus including such a conventional lighting lens can improve color rendering properties due to the color adjustment unit.

Accordingly, it is an object of the present invention to provide a light flux controlling member that can improve color rendering properties and prevent reductions in performance of the light flux controlling member and in illuminance on an illuminated surface when a pseudo-white LED is used, and an illumination apparatus including the light flux controlling member.

It is another object of the present invention to provide a light flux controlling member that can adjust a color from an LED other than white, and prevent reductions in performance of the light flux controlling member and in illuminance on an illuminated surface, and an illumination apparatus including the light flux controlling member.

### Solution to Problem

A light flux controlling member according to the present invention is a light flux controlling member for receiving light emitted from a light-emitting device and emitting the incident light to an illuminated surface while controlling the incident light to be light having desired light distribution characteristics, the member including: a light incidence surface that faces the light-emitting device and receives the light emitted from the light-emitting device; a light-controlling emission surface for emitting the light incident on the light incidence surface while controlling the direction of the light; and a color adjustment unit that contains a color adjusting material, the color adjustment unit receiving the light incident on the light incidence surface and emitting light in a color different from the color of the light emitted from the light-emitting device, in which the color adjustment unit is disposed at a portion through which sub-rays other than main rays pass and not at a portion through which the main rays passes, the main rays being rays emitted from the light-emitting device and having a luminous intensity equal to or more than a predetermined percentage of a maximum luminous intensity.

An illumination apparatus according to the present invention includes: a light-emitting device for emitting pseudo white light obtained by mixing two complementary color light components; and the above mentioned light flux controlling member.

### Advantageous Effects of Invention

According to the present invention, light emitted from a light-emitting device and having a light distribution property of a relatively high luminous intensity is not scattered or absorbed by particles in a color adjustment unit and is emitted to an illuminated surface while being effectively controlled by the light flux controlling member, which can prevent reductions in performance of the light flux controlling member and in illuminance on the illuminated surface, as compared with a color adjustment unit disposed in the optical path of light having a high luminous intensity emitted from a light-emitting device. Furthermore, according to the present invention, light having a relatively low luminous intensity is scattered by particles in the color adjustment unit and a color different from the light-emitting color of the LED is emitted, which can enhance color rendering properties, as compared with no color adjustment unit provided.

### BRIEF DESCRIPTION OF DRAWING

FIG. 1 illustrates the shapes of a lighting lens and an illumination apparatus according to Embodiment 1 of the present invention;

FIG. 2 illustrates the shape of the lighting lens shown in FIG. 1, as viewed from the LED;

FIG. 3 illustrates the shape of the lighting lens shown in FIG. 1, as viewed from the illuminated surface;

FIG. 4 shows the relationship between the LED emission angle (horizontal axis) and the luminous intensity (vertical axis);

FIG. 5 shows the simulation results of light scattering inside the lighting lens according to this embodiment;

FIG. 6 is a schematic view of a measuring instrument used to demonstrate the effect of the lighting lens according to this embodiment;

FIG. 7 shows the relationship between the LED emission angle (horizontal axis) and the illuminance on an illuminated surface (vertical axis);

FIG. 8 illustrates a lighting lens of Variation 1 according to Embodiment 2 of the present invention;

FIG. 9 illustrates a lighting lens of Variation 2 according to Embodiment 2 of the present invention;

FIG. 10 illustrates a lighting lens of Variation 3 according to Embodiment 2 of the present invention;

FIG. 11 illustrates a lighting lens of Variation 3 according to Embodiment 2 of the present invention;

FIG. 12 illustrates a lighting lens of Variation 3 according to Embodiment 2 of the present invention;

FIG. 13 illustrates a lighting lens of Variation 4 according to Embodiment 2 of the present invention;

FIG. 14 illustrates a lighting lens of Variation 5 according to Embodiment 2 of the present invention;

FIG. 15 illustrates a lighting lens of Variation 6 according to Embodiment 2 of the present invention; and

FIG. 16 illustrates a lighting lens of another variation according to the present invention.

### DESCRIPTION OF EMBODIMENTS

Embodiments of the present invention will be described in detail with reference to the accompanying drawings.

### Embodiment 1

### Configuration of Illumination Apparatus

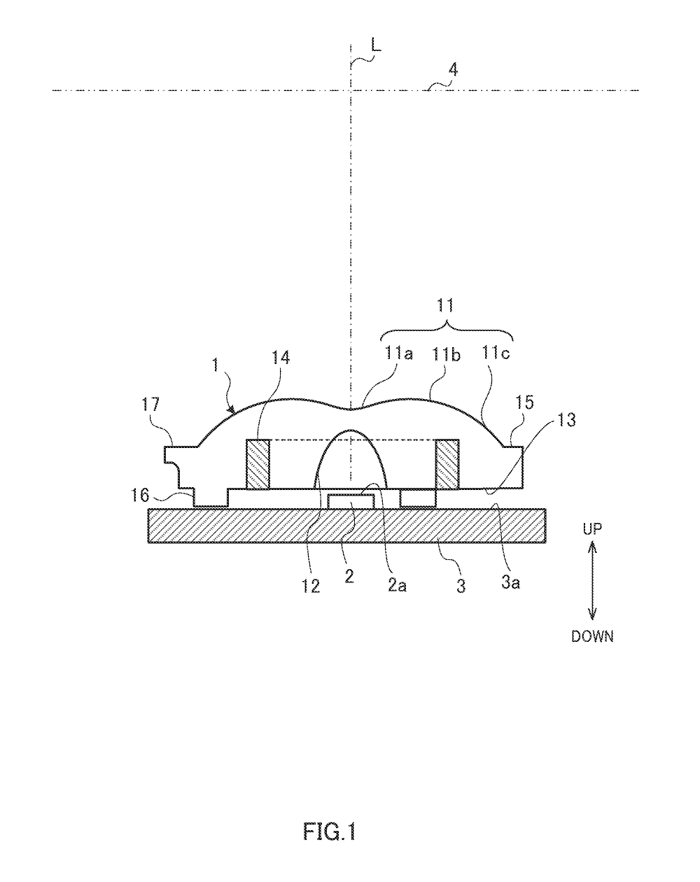

FIG. 1 illustrates the shapes of a lighting lens as a light flux controlling member and an illumination apparatus according to Embodiment 1.

As shown in FIG. 1, lighting lens 1 according to this embodiment faces LED 2, which is a light-emitting device. Lighting lens 1 and LED 2 are mounted on substrate 3. The illumination apparatus includes lighting lens 1, LED 2 and substrate 3. Lighting lens 1 is mounted such that its central axis is aligned to a reference optical axis L for LED 2 (described below).

LED 2 is a pseudo-white LED that emits pseudo white color generated by mixing blue light emitted from a blue-light emitting LED chip and yellow light yielded from the blue light which excites a yellow fluorescent material in a sealing material covering the LED chip. LED 2 emits a white light flux from the center of emission surface 2a within a predetermined range of angles with respect to the reference optical axis L at an emission angle of 0°, which is an optical axis of light emitted in the direction normal to emission surface 2a and the center of an emitting light flux from LED 2.

The lighting lens 1 receives white light emitted from LED 2. Lighting lens 1 emits the white incident light to an illuminated surface side 4 while controlling the light so as to obtain desired light distribution properties. Lighting lens 1 is composed of, for example, a transparent resin material such as polymethyl methacrylate (PMMA), polycarbonate (PC) and epoxy resin (EP), or transparent glass.

### Shape and Configuration of Lighting Lens 1

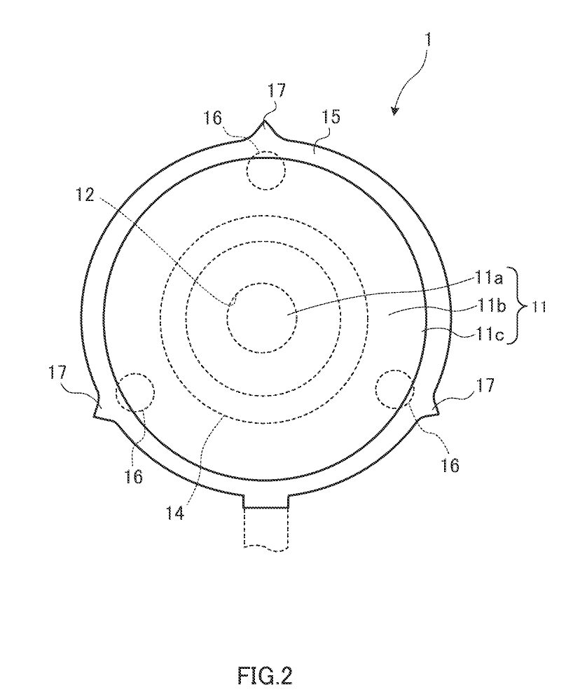

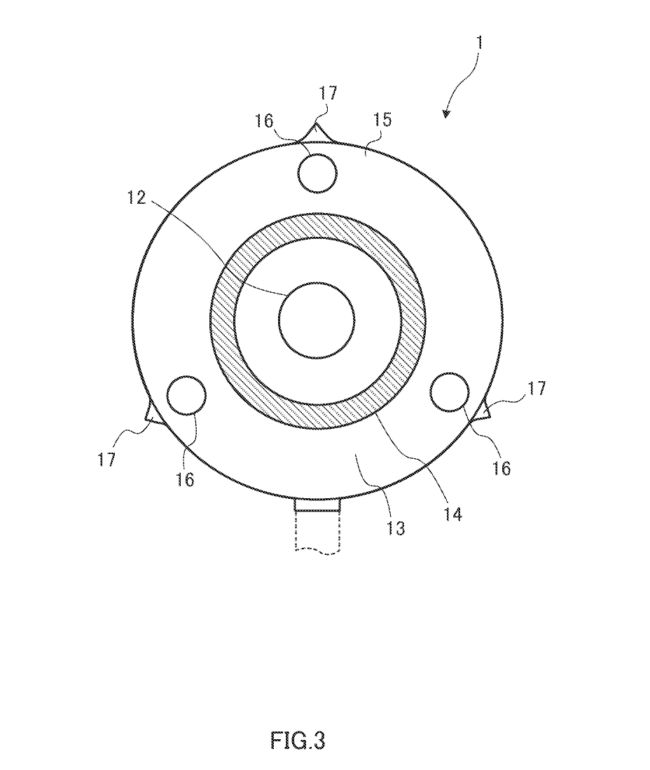

FIG. 2 illustrates the shape of lighting lens 1 shown in FIG. 1, as viewed from LED 2. FIG. 3 illustrates the shape of lighting lens 1 shown in FIG. 1, as viewed from illuminated surface 4.

As shown in FIGS. 1 to 3, lighting lens 1 includes light-controlling emission surface 11, dent 12, back surface 13, color adjustment unit 14, flange 15, tubular leg 16, and projection 17.

Light-controlling emission surface 11 faces illuminated surface 4 and emits the light that has entered the inside of lighting lens 1 while controlling the emission direction thereof.

Dent 12 faces LED 2 and causes the light emitted from LED 2 within a predetermined angle range with respect to the reference optical axis L to enter the inside of lighting lens 1. The surface shape of the dent allows the propagation direction of the incident light in lighting lens 1 to be controlled. Dent 12 can also cause part of the incident light that has been reflected outside the lens to be incident on the lens.

Back surface 13 extends in an outer radial direction from the edge of the opening of dent 12, and causes the light that has been emitted out of a predetermined angle range with respect to the reference optical axis L and thus failed to enter dent 12 to enter the inside of lighting lens 1.

Color adjustment unit 14 is excited by the light emitted from LED 2 and emits light of a color different from the light-emitting color of LED 2. Color adjustment unit 14 is formed by casting a resin containing a red fluorescent material as a color adjusting material in a toroidal groove having a predetermined depth from back surface 13 and a rectangular cross-section. The methods for forming color adjustment unit 14 include well-known two-color formation and insert molding. Alternatively, color adjustment unit 14 formed separately from lighting lens 1 may be inserted in the groove of lighting lens 1. The red fluorescent material includes a magenta fluorescent material. Examples of the resin containing such fluorescent material include thermoplastic, thermosetting, or photocrosslinkable translucent resins, such as polymethyl methacrylate (PMMA), polycarbonate (PC), epoxy resin (EP), and polydimethylsiloxane (PDMS).

Flange 15 is formed into a substantially toroidal shape surrounding the light-controlling emission surface 11 in the outer radial direction. Legs 16 are provided at equally-spaced three positions on the periphery of the inner concentric circle of flange 15 and is bonded on surface 3a of substrate 3. Three projections 17 are provided in the outer radial direction from flange 15 at positions corresponding to those of legs 16, and are used as positioning guides. The shapes of flange 15, leg 16, and projection 17 can be modified, as appropriate, provided that they do not significantly affect the light flux control.

Lighting lens 1 is secured to an appropriate position on substrate 3 by bonding legs 16 onto surface 3a of substrate 3.

### Details of Light-Controlling Emission Surface 11

As shown in FIG. 1, light-controlling emission surface 11 upwardly projects from flange 15 (toward illuminated surface 4).

Light-controlling emission surface 11 consists of first emission surface 11a which extends within predetermined radius around the reference optical axis L (central axis), second emission surface 11b which continuously extends from first emission surface 11a in the outer radial direction, and third emission surface 11c which continuously extends from second emission surface 11b in the outer radial direction up to flange 15.

First emission surface 11a has a smooth concave shape like a portion of a ball. This shape allows the light emitted through first emission surface 11a to be efficiently diffused on illuminated surface 4.

Second emission surface 11b has a smooth convex shape and is formed into a substantially hollow disk surrounding first emission surface 11a.

Third emission surface 11c is an inclined surface having a substantially linear cross-section and is formed into a substantially hollow disk surrounding second emission surface 11b. Third emission surface 11c may be curved unless it hinders wide-ranging uniform emission from lighting lens 1.

### Relation Between Emission Angle and Luminous Intensity of LED 2

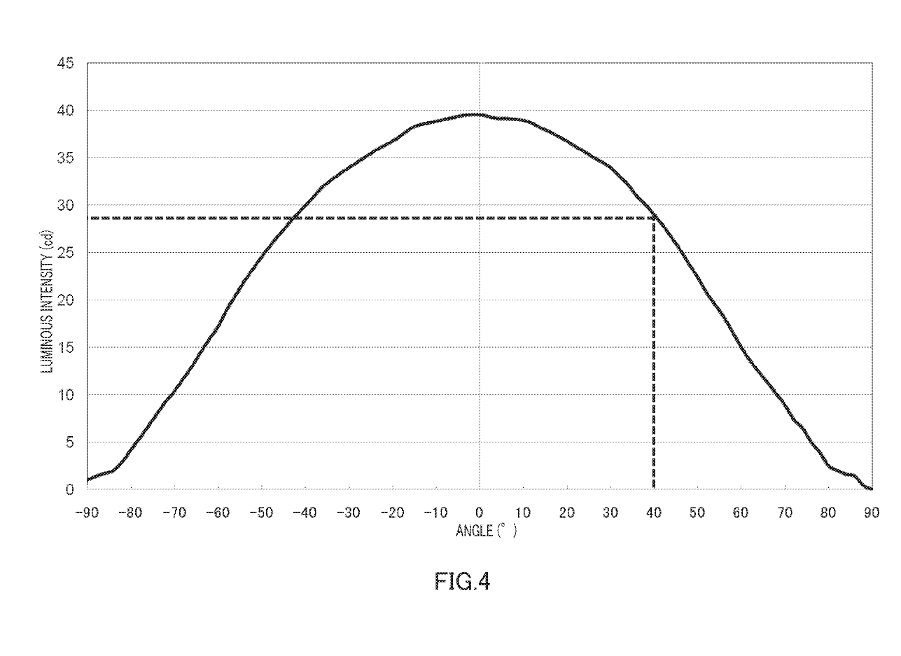

FIG. 4 shows the relationship between the emission angle (horizontal axis) and luminous intensity (vertical axis) of the LED 2. As shown in FIG. 4, the luminous intensity reaches its maximum at reference optical axis L (emission angle of 0°) and decreases as the angle expands from reference optical axis L.

In considering that light having a higher luminous intensity significantly affects the illuminance at the illuminated surface, the present invention is characterized in that the color adjustment unit is not disposed at a portion through which rays having a luminous intensity equal to or more than a predetermined percentage of the maximum luminous intensity (hereinafter called “main rays”) pass and is disposed at a portion through which rays other than the main rays (hereinafter called “sub-rays”) pass.

In this embodiment, as shown in FIG. 4, rays having a luminous intensity equal to or more than 70% of the maximum luminous intensity are referred to as “main rays,” In this embodiment, the main rays are emitted from emission surface 2a of LED 2 within the range of ±40° with respect to reference optical axis L (central axis).

### Scattering Simulation

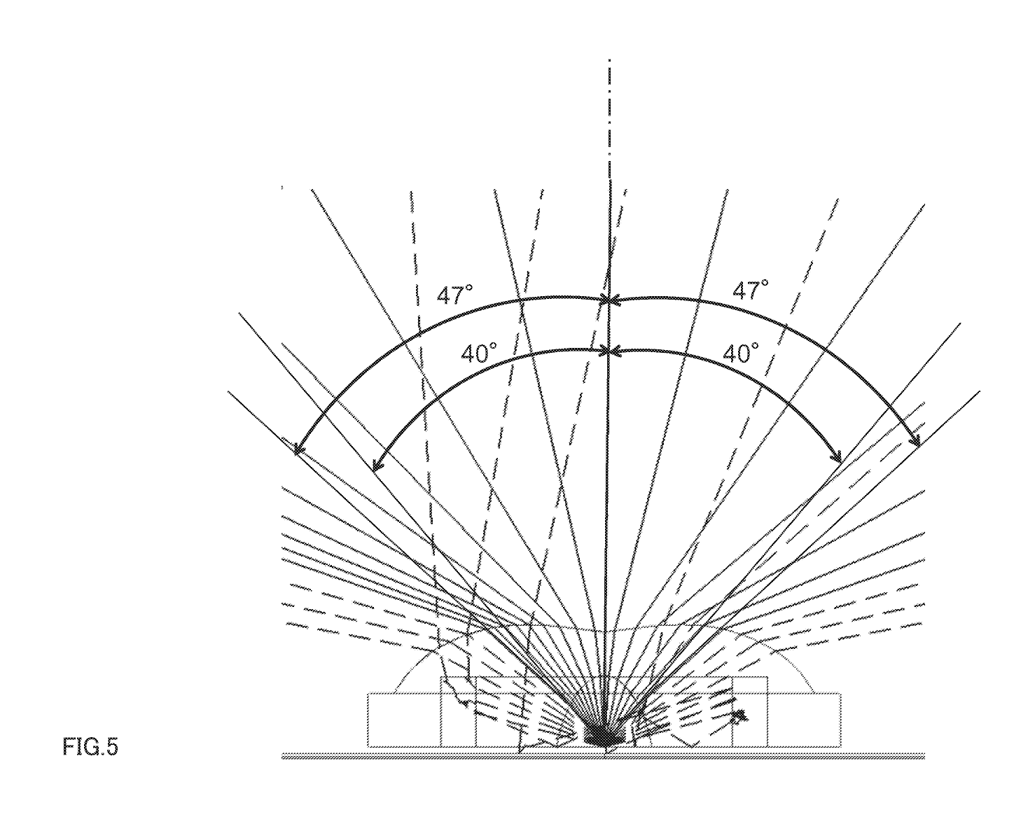

FIG. 5 shows the simulation results of light scattering inside lighting lens 1. In FIG. 5, solid lines indicate the main rays and dotted lines indicate sub-rays.

As shown in FIG. 5, in lighting lens 1 according to this embodiment, incident main rays are emitted through light-controlling emission surface 11 to be incident on illuminated surface 4, without passing through color adjustment unit 14. As a result, the illuminance of the illumination apparatus according to this embodiment shows no significant difference from that of lighting lens 1 without color adjustment unit 14.

The lines defined by ±40° from the reference optical axis L at the intersection between emission surface 2a of LED 2 and the reference optical axis L (central axis), in light-controlling emission surface 11, substantially corresponds to the boundary between first emission surface 11a and second emission surface 11b of light-controlling emission surface 11 (the inflection point between the concave and convex curves).

In addition, the main rays incident on dent 12 of lighting lens 1 diverge to an angle of about ±47° by refraction.

In contrast, in lighting lens 1 according to this embodiment, part of incident sub-rays is scattered by particles in color adjustment unit 14 and emitted through light-controlling emission surface 11 in a color different from the light-emitting color of LED 2. As a result, the illumination apparatus according to this embodiment enhances color rendering properties, as compared with lighting lens 1 without color adjustment unit 14.

### Results of Measurements of Color Rendering Properties and Illuminance

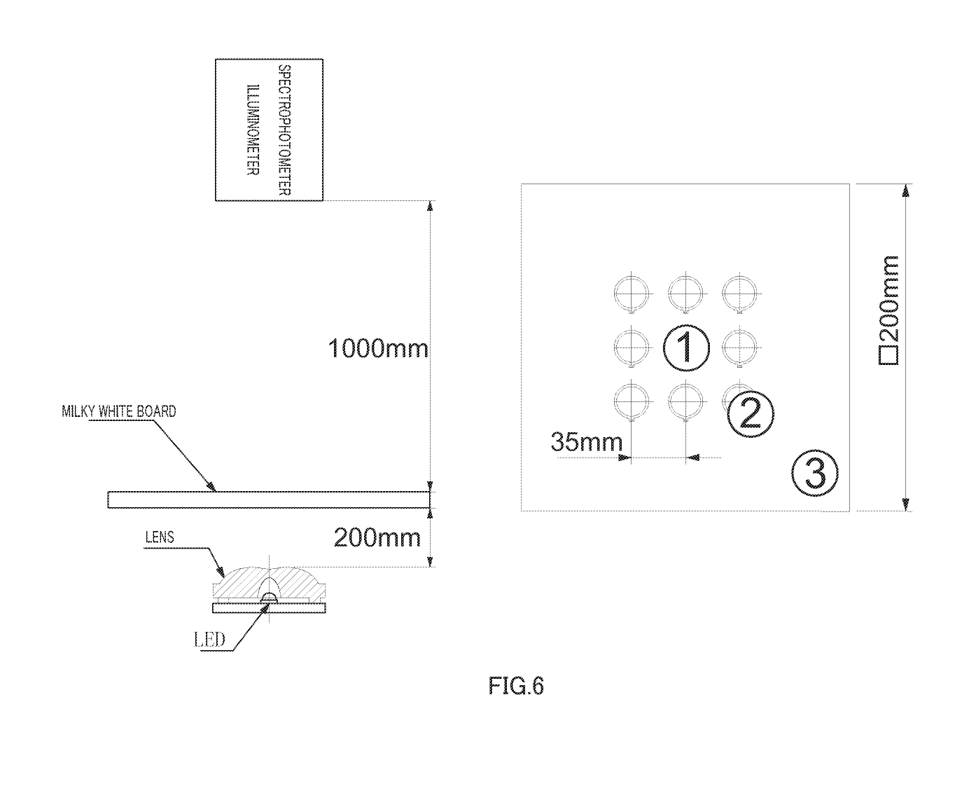

To prove the above-mentioned effect, the inventor of the present application measured the illuminance and color rendering properties of prototyped lighting lenses with a measuring instrument, as shown in FIG. 6. The color rendering properties were measured at three positions as shown in FIG. 6.

The prototyped lighting lenses are of three types: a first or normal type without a color adjustment unit, a second type having a simply colored lighting lens, and a third type with a color adjustment unit as shown in FIG. 1. The prototyped lighting lenses have the shape as shown in FIG. 1.

The results of measurement showed that the second type had a illuminance 19.5% lower than that of the first type while the third type had a illuminance 11.8% lower. The average color rendering indexes (Ra) indicating the color rendering properties were 68, 76.6 and 76.3 for the first, second and third types, respectively.

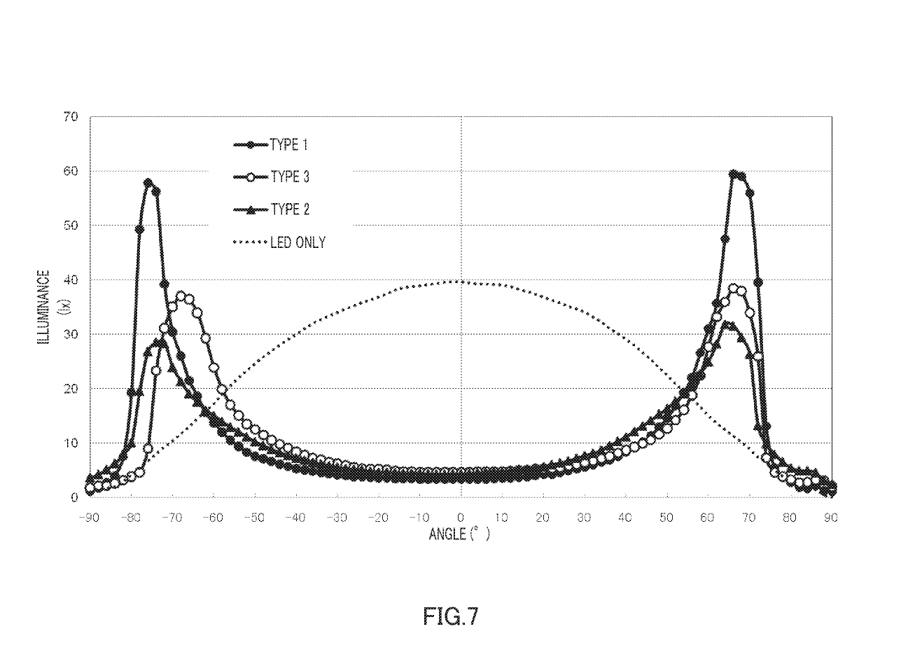

FIG. 7 shows the relationship between the emission angle (horizontal axis) of LED 2 and the illuminance (vertical axis) at illuminated surface 1 in away from LED 2. As evident from the above results of measurement and FIG. 7, the lighting lens according to this embodiment can prevent the illuminance reduction more effectively than the simply colored one although it has slightly reduced illuminance as compared with a lighting lens without a color adjustment unit. Lighting lens 1 according to this embodiment can enhance color rendering properties, just as the simply colored lighting lens.

### Advantageous Effect of Embodiment 1

As described above, according to this embodiment, light having a relatively high luminous intensity is incident on an illuminated surface without being scattered or absorbed by particles in the color adjustment unit, which can prevent decreased illuminance at an illuminated surface more effectively than an embodiment without a color adjustment unit. In addition, according to this embodiment, light having a relatively low luminous intensity is scattered by particles in the color adjustment unit and emitted in a color different from light-emitting color of the LED, which can enhance color rendering properties more effectively than an embodiment without a color adjustment unit.

### Embodiment 2

In Embodiment 1, formation of the color adjustment unit by casting a resin containing a red fluorescent material into a toroidal groove having a predetermined depth from the back surface and a rectangular cross-section was described. The present invention is not restricted to this embodiment; the same effect can be achieved provided that a color adjustment unit is disposed at a portion through which the sub-rays pass and not at a portion through which the main rays pass.

Embodiment 2 describes variations of the lighting lens described in Embodiment 1 including color adjustment units that have different shapes and are disposed at different positions.

### Variation 1

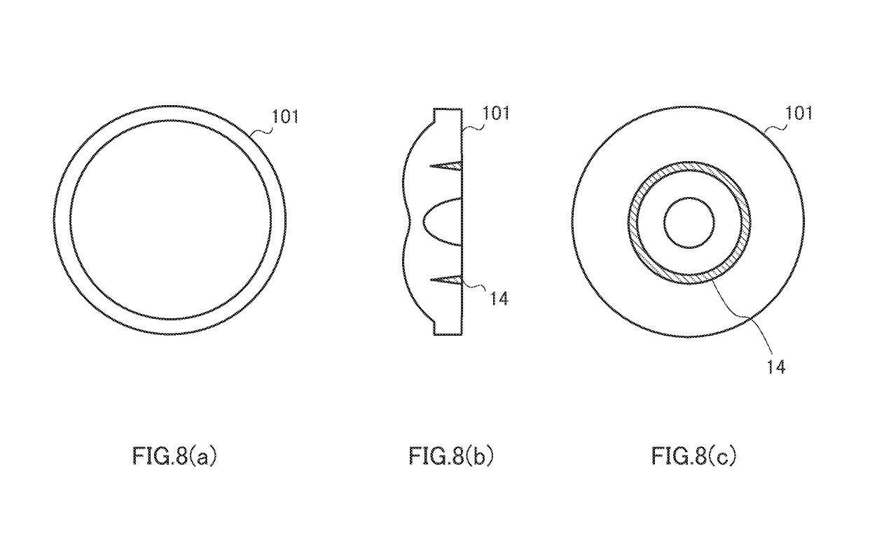

FIG. 8 illustrates a lighting lens of Variation 1 according to this embodiment. FIG. 8(a) is a top view, FIG. 8(b) is a side cross-sectional view, and FIG. 8(c) is a bottom view. Lighting lens 101 (Variation 1) shown in FIG. 8 differs from lighting lens 1 shown in FIG. 1 in that color adjustment unit 14 has a different cross-sectional shape.

### Variation 2

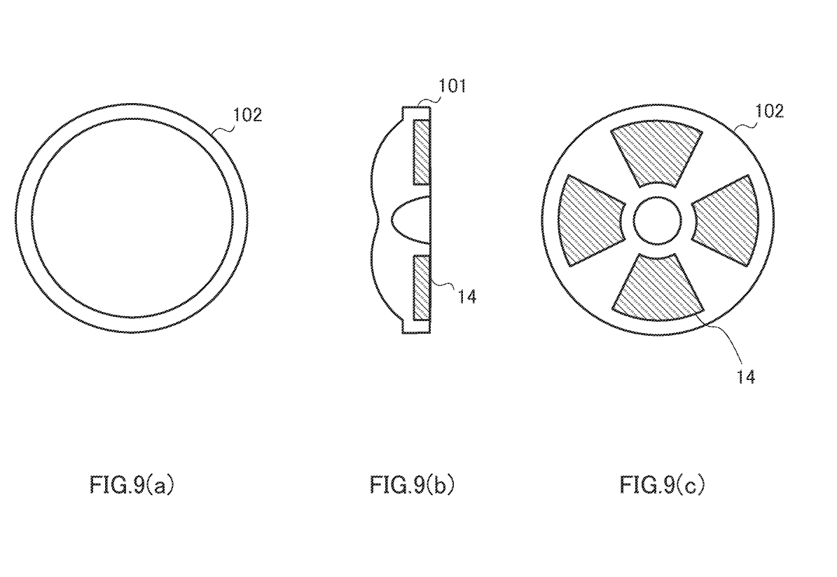

FIG. 9 illustrates a lighting lens of Variation 2 according to this embodiment. FIG. 9(a) is a top view, FIG. 9(b) is a side cross-sectional view, and FIG. 9(c) is a bottom view. Lighting lens 102 (Variation 2) shown in FIG. 9 differs from lighting lens 1 shown in FIG. 1 in that color adjustment unit 14 has a different cross-sectional shape and is formed in part of the toroidal groove.

### Variation 3

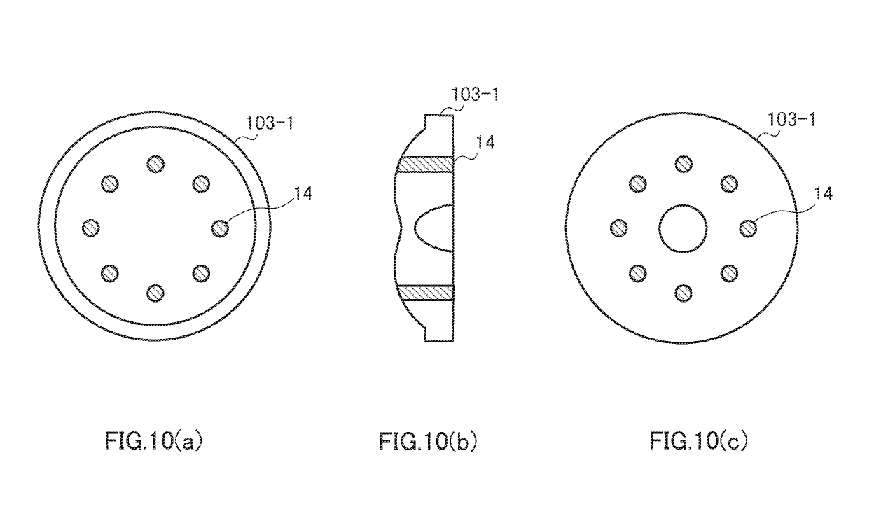

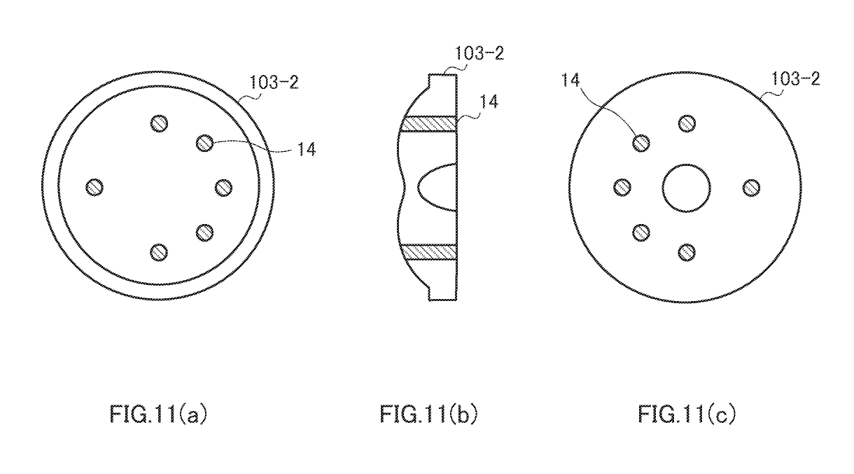

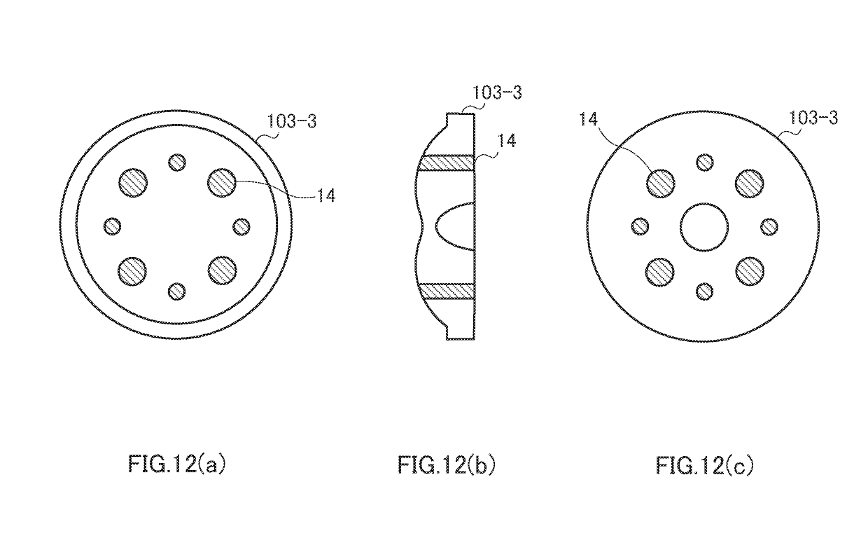

FIGS. 10 to 12 illustrate a lighting lens of Variation 3 according to this embodiment. In each of FIGS. 10 to 12, (a) is a top view, (b) is a side cross-sectional view, and (c) is a bottom view. Lighting lens 103-1 (Variation 3-1) shown in FIG. 10 has color adjustment units 14 formed in a plurality of through holes with a predetermined radius which are drilled from back surface 13. Lighting lens 103-2 (Variation 3-2) shown in FIG. 11 is the same as that in FIG. 10 except that the number of through holes differs from that of lighting lens 103-1 and these through holes are positioned asymmetrically. Lighting lens 103-3 (Variation 3-3) shown in FIG. 12 differs from lighting lens 103-1 shown in FIG. 10 in that through holes have different radiuses.

### Variation 4

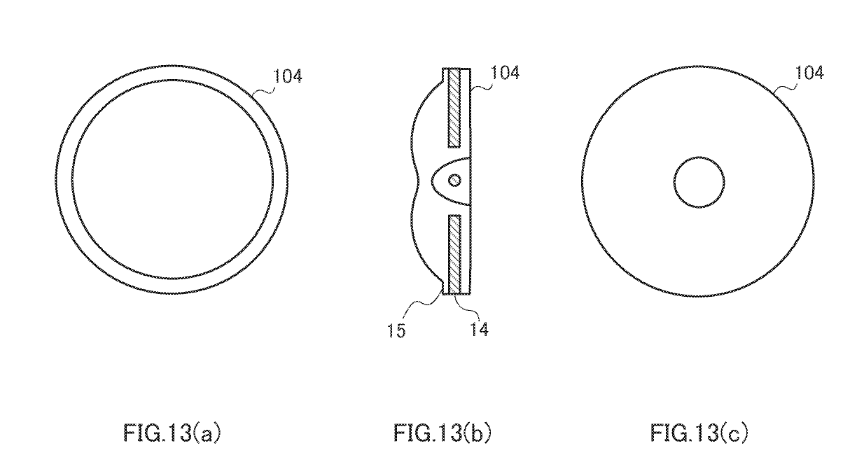

FIG. 13 illustrates a lighting lens of Variation 4 according to this embodiment. FIG. 13(a) is a top view, FIG. 13(b) is a side cross-sectional view, and FIG. 13(c) is a bottom view. Lighting lens 104 (Variation 4) shown in FIG. 13 has color adjustment units 14 formed in a plurality of through holes with a predetermined radius and depth which are drilled from flange 15 (side).

### Variation 5

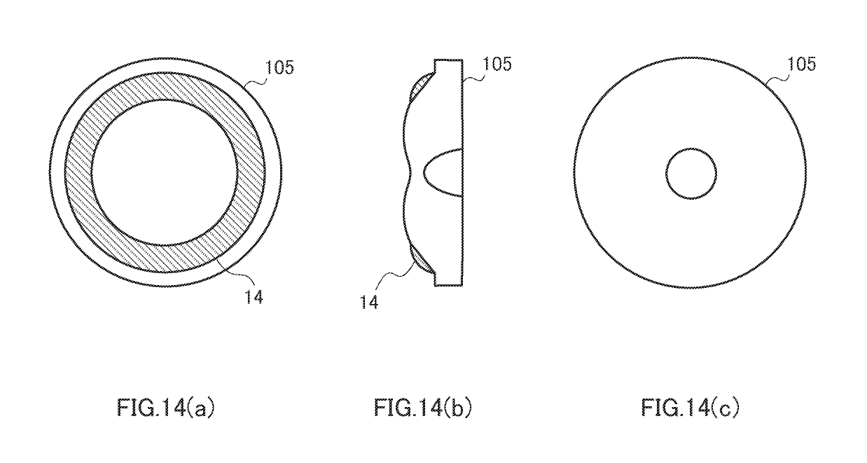

FIG. 14 illustrates a lighting lens of Variation 5 according to this embodiment. FIG. 14(a) is a top view, FIG. 14(b) is a side cross-sectional view, and FIG. 14(c) is a bottom view. Lighting lens 105 (Variation 5) shown in FIG. 14 has color adjustment unit 14 formed on light-controlling emission surface 11 (third emission surface 11c). Such color adjustment unit 14 can be formed by coating or printing.

### Variation 6

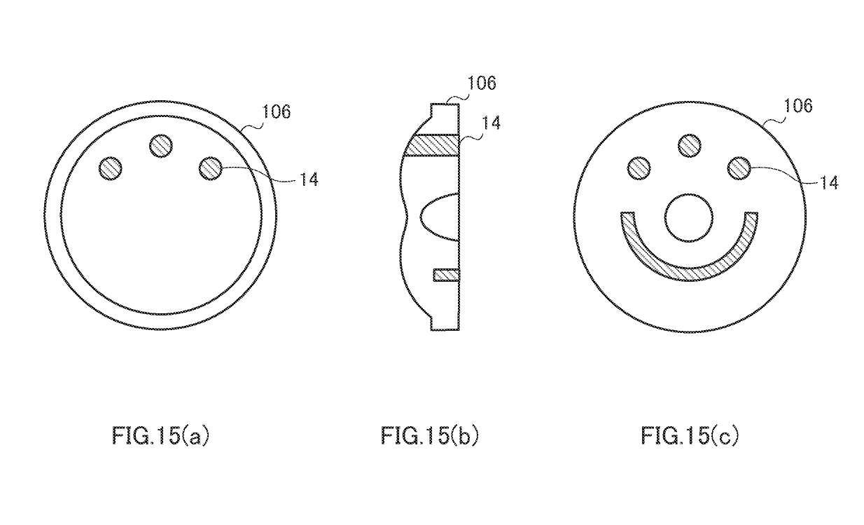

FIG. 15 illustrates a lighting lens of Variation 6 according to this embodiment. FIG. 15(a) is a top view, FIG. 15(b) is a side cross-sectional view, and FIG. 15(c) is a bottom view. Lighting lens 106 (Variation 6) shown in FIG. 15 has color adjustment units 14 formed in through holes and a groove.

### Other Embodiments

In the present invention, a fluorescent material as a color adjusting material contained in color adjustment unit 14 may have different concentrations or colors, depending on positions. The present invention may use a pigment or dye as a color adjusting material, which may have different concentrations or colors, depending on positions. Furthermore, the present invention may use a combination of multiple color adjusting materials. For example, in FIG. 1, color adjustment unit 14 may contain different concentrations of fluorescent material between a portion near back surface 13 and a portion away back surface 13. Alternatively, in FIG. 10, different through holes may contain fluorescent materials of different colors.

The above descriptions show exemplary preferred embodiments of the present invention and should not be used as a limitation of the present invention.

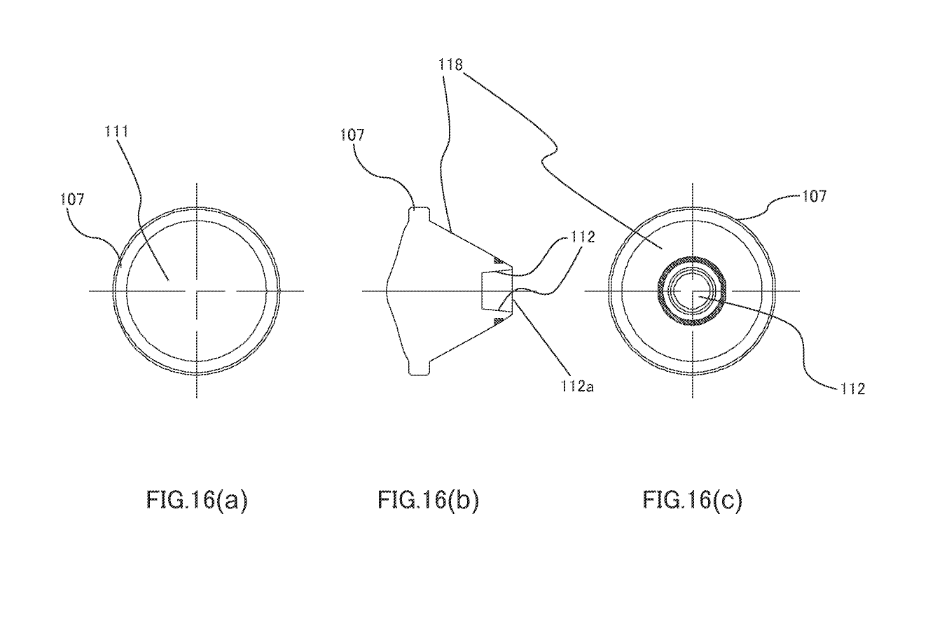

For example, lighting lens 107, as shown in FIG. 16, having a shape different from those described in the above-mentioned embodiments is also applicable to the present invention. FIG. 16(a) is a top view, FIG. 16(b) is a side cross-sectional view, and FIG. 16(c) is a bottom view. Unlike lighting lenses 1, 101, 102, 103, 104, 105, and 106 in Embodiments 1 and 2, lighting lens 107 has side surface 118 that extends from outer edge 112a of incidence surface 112 towards emission surface 111 while expanding the radius. The light from an emission angle having maximum luminous intensity and the light within a given range from the emission angle among the light emitted from such lighting lens 107 reach emission surface 111 directly from incidence surface 112, without being reflected on side surface 118, and are emitted from emission surface 111. The light travelling outside the predetermined angle range is fully reflected on side surface 118 after passing through incidence surface 112 and reaches the emission surface 111. Thus, the light fully reflected on side surface 118 is emitted such that its radiating area overlaps with that of the light that directly reaches and is emitted from emission surface 111, thereby allowing color adjustment of the light emitted from LED 2 by placing color adjustment unit 14 in the optical path of light travelling from incidence surface 112 to side surface 118.

The entire disclosure of the specification, drawings and abstract of Japanese Patent Application No. 2010-073690 filed on Mar. 26, 2010 is incorporated in this application by reference.

### INDUSTRIAL APPLICABILITY

A lighting lens and an illumination apparatus according to the present invention can be widely used in back-lights of television monitors and monitors of personal computers, interior lights, and various lighting apparatuses.

### REFERENCE SIGNS LIST

1, 101, 102, 103, 104, 105, 106, 107: lighting lens
2: LED
3: substrate
11: light-controlling emission surface
12: dent
13: back surface
14: color adjustment unit

1. A light flux controlling member for receiving light emitted from a light-emitting device and emitting the incident light to an illuminated surface while controlling the incident light to be light having desired light distribution characteristics, the member comprising:
a light incidence surface that faces the light-emitting device and receives the light emitted from the light-emitting device;
a light-controlling emission surface for emitting the light incident on the light incidence surface while controlling the direction of the light; and
a color adjustment unit that contains a color adjusting material, the color adjustment unit receiving the light incident on the light incidence surface and emitting light in a color different from the color of the light emitted from the light-emitting device, wherein
the color adjustment unit is disposed at a portion through which sub-rays other than main rays pass and not at a portion through which the main rays passes, the main rays being rays emitted from the light-emitting device and having a luminous intensity equal to or more than a predetermined percentage of a maximum luminous intensity.

2. The light flux controlling member according to claim 1, wherein the main rays have a luminous intensity equal to or more than 70% of the maximum luminous intensity.

3. The light flux controlling member according to claim 1, wherein the color adjusting material is any one or any combination of a fluorescent material, a pigment and a dye.

4. The light flux controlling member according to claim 1, wherein the light-controlling emission surface comprises:
a first emission surface that extends within a predetermined radius around a reference optical axis, the reference optical axis being the center of a light flux emitted from the light-emitting device; and
a second emission surface that continuously extends from the first emission surface in the outer radial direction, wherein
the first emission surface has a smooth concave shape, the second emission surface has a smooth convex shape, and in a cross-section including the reference optical axis, a connection point between the first emission surface and the second emission surface represents an inflection point, and
the color adjustment unit is formed on the opposite side of the reference optical axis with respect to a virtual surface, the virtual surface being obtained by rotating a virtual line about the reference optical axis, the virtual line being drawn by connecting a light emitting point and the inflection point, the light emitting point being a point at which a light-emission surface of the light-emitting device and the reference optical axis intersects.

5. The light flux controlling member according to claim 1, further comprising:
a side surface that extends from an outer edge of the light incidence surface towards the light controlling emission surface while expanding the radius, wherein
the color adjustment unit is placed in the optical path of light travelling from the light incidence surface to the side surface among the light incident from the light incidence surface.

6. An illumination apparatus comprising:
a light-emitting device for emitting pseudo white light obtained by mixing two complementary color light components; and
the light flux controlling member according to claim 1.
